(19) United States
(12) Patent Application Publication
(10) Pub. No.: US 2008/0176004 A1
(43) Pub. Date: Jul. 24, 2008

(54) COATING TREATMENT APPARATUS, SUBSTRATE TREATMENT SYSTEM, COATING TREATMENT METHOD, AND COMPUTER STORAGE MEDIUM

(75) Inventor: Makoto MURAMATSU, Nirasaki-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 11/972,988

(22) Filed: Jan. 11, 2008

(30) Foreign Application Priority Data
Jan. 19, 2007 (JP) 2007-010165
Jan. 19, 2007 (JP) 2007-010179
Jun. 4, 2007 (JP) 2007-147694

(51) Int. Cl. C08F 2/48; B05C 11/02

(52) U.S. Cl. 427/508; 118/620

(57) ABSTRACT

In the present invention, a spin chuck which horizontally holds a substrate by vacuum suction is provided inside a treatment container of a coating treatment apparatus. Above the spin chuck, a coating nozzle is located for applying a coating solution containing a coating film forming component in the liquid state onto the central portion of the surface of the substrate. In an upper portion of the treatment container, an irradiation unit is provided which applies ultraviolet rays to the substrate on the spin chuck. After applying the coating solution onto the pattern on the substrate from the coating nozzle, ultraviolet rays are applied from the irradiation unit to the applied coating solution to form a coating film.

### BACKGROUND OF THE INVENTION

1. Field of the Invention

The present invention relates to a coating treatment apparatus for forming a coating film over a pattern formed on a substrate, a substrate treatment system, a coating treatment method, and a computer storage medium.

2. Description of the Related Art

In a process of manufacturing a semiconductor device in a multilayer wiring structure, for example, resist coating treatment of applying a resist solution above a semiconductor wafer (hereinafter, referred to as a “wafer”) to form a resist film, exposure processing of exposing the resist film to light under a predetermined pattern, and developing treatment of developing the exposed resist film and so on are performed in sequence, to form a predetermined resist pattern above the wafer. Etching treatment of the wafer is performed using this resist pattern as a mask, and processing of removing the resist film is then performed to form a predetermined pattern on the wafer. The process of forming a predetermined pattern in a predetermined layer is normally repeatedly performed 20 to 30 times to manufacture a semiconductor device in the multilayer structure.

Incidentally, when a predetermined pattern is repeatedly formed above the wafer in such a manner, the surface on which a resist solution is applied needs to be flat in order to form a resist film of an (n+1)-th layer at an appropriate height after formation of a predetermined pattern in an n-th layer.

Hence, conventionally, a coating film has been formed over a predetermined pattern on a wafer and its surface has been planarized. The formation of such a coating film is performed, for example, by applying a coating solution containing a coating film forming component in the solid state and a solvent onto the predetermined pattern on the wafer, and curing the applied coating solution by heating. As the coating solution, for example, an SOG (Spin On Glass) material is used (“Improvement in SOG Process for Multilayer Wiring Structure” by Ohashi Naofumi et. al, the Transactions of the Institute of Electronics, Information and Communication Engineers, C-II, Vol. J78-C-II, No. 5, 1995).

However, as shown in FIG. 28, when such a conventional coating solution is applied onto a predetermined pattern P on a wafer W, the coating solution has not smoothly spread over projections and depressions of the predetermined pattern P on the wafer W because the coating film forming component in the solid state in the coating solution has poor flowability. As a result, a coating film R in an S region where holes H of the pattern P are formed sinks as compared to that in a region T where any holes H of the pattern P are not formed, thereby causing a difference in height of the coating film R, a so-called bump B. Accordingly, the surface of the conventional coating film R is not planarized, bringing about a problem of causing a bump also in a resist film to be formed on the coating film R.

### SUMMARY OF THE INVENTION

The present invention has been developed in consideration of the above points, and its object is to planarize the surface of a coating film when forming the coating film over a predetermined pattern formed on a substrate.

To attain the above object, the present invention is a coating treatment apparatus for forming a coating film over a pattern formed on a substrate, including: a treatment container for housing the substrate, including a transfer-in/out port for transferring-in/out the substrate; a coating nozzle for applying a coating solution containing a coating film forming component in a liquid state onto the pattern on the substrate housed in the treatment container; and an irradiation unit for applying ultraviolet rays to the coating solution applied over the pattern on the substrate.

According to the coating treatment apparatus of the present invention, when the substrate is transferred into the treatment container and the coating solution containing a coating film forming component in a liquid state is then applied onto the pattern on the substrate by the coating nozzle, the coating solution can smoothly spread over projections and depressions of the pattern on the substrate because the coating film forming component in the liquid state contained in the coating solution has good flowability. Therefore, no bump is created in the coating film to be formed over the pattern on the substrate, thus planarizing the surface of the coating film.

Further, the coating film forming component in the liquid state contained in the coating solution applied over the pattern on the substrate has here a property of easily sublimating because it is low molecular and its molecules are not bound. When this coating film forming component is heated, the coating solution further easily sublimates. A conventional coating film is formed by curing a coating solution by heating it, so that if a coating solution is used which has a coating film forming component in the liquid state, the coating solution sublimates when the coating solution is cured. With the irradiation unit of the present invention, however, the ultraviolet rays are applied to the coating solution applied over the pattern on the substrate to cure the coating solution in order to form a coating film over the pattern on the substrate, thereby eliminating the necessity to heat the coating solution, so that the sublimation of the coating solution can be further suppressed as compared to the prior art. Accordingly, the reduction in film thickness of the coating film to be formed can be suppressed.

The irradiation unit may be provided in an upper portion of the treatment container. Since the irradiation unit can apply the ultraviolet rays to the substrate housed in the treatment container, the application of the coating solution and the application of the ultraviolet rays to the substrate can be performed with the substrate being housed in the treatment container. Accordingly, the processing from the application of the coating solution to the application of the ultraviolet rays can be consecutively performed, thereby accordingly reducing the processing time.

The irradiation unit may be provided at an upper portion of the transfer-in/out port. This irradiation unit can apply the ultraviolet rays to the coating solution over the pattern on the substrate when the substrate is transferred to the outside through the transfer-in/out port of the treatment container after the coating solution is applied onto the pattern on the substrate.

A rotatable spin chuck for holding the substrate may be provided in the treatment container, and a range where the ultraviolet rays are applied to the coating solution over the pattern on the substrate by the irradiation unit may be a region from a center of the substrate to an end portion of the substrate and greater. The application of the ultraviolet rays to the substrate rotated by the spin chuck as described above can form a coating film over the entire surface of the substrate only by applying the ultraviolet rays to at least a range from the center of the substrate to the end portion of the substrate. Note that in this case, the irradiation unit may be provided beside the coating nozzle.

The coating nozzle may be a nozzle having a discharge port in a slit form extending in a direction of a width of the substrate, and the irradiation unit may have a form extending in the direction of the width of the substrate parallel to the coating nozzle and move in synchronization with the coating nozzle. The coating nozzle and the irradiation unit are moved in synchronization as described above, whereby the time period from when the coating solution is applied to when the ultraviolet rays are applied can be controlled to be constant within the entire region within the plane of the substrate. Note that the irradiation unit may be provided beside the coating nozzle. Further, the coating nozzle and the irradiation unit may have independent moving mechanisms, and a plurality of the irradiation units may be provided.

The coating treatment apparatus may include a control unit for conducting control such that the ultraviolet rays are applied from the irradiation unit to the coating solution on the region of the substrate immediately after the coating solution is applied onto the region from the coating nozzle. The control unit ensures that the coating solution applied over the pattern on the substrate is cured by application of the ultraviolet rays immediately after the coating solution is applied to the substrate, thus suppressing sublimation of the coating solution.

According to another aspect, the present invention is a substrate treatment system including a coating treatment apparatus for applying a coating solution at least onto a pattern formed on a substrate, and a transfer unit for transferring the substrate into/from the coating treatment apparatus. Further, the transfer unit includes a transfer arm for supporting and transferring the substrate, and an irradiation unit for applying ultraviolet rays to the coating solution over the pattern on the substrate, the substrate being supported by the transfer arm.

In this case, after the coating solution is applied onto the pattern on the substrate in the coating treatment apparatus, the substrate is transferred by the transfer arm to the transfer unit, and the ultraviolet rays are applied to the coating solution over the pattern on the substrate from the irradiation unit in the transfer unit with the substrate being supported by the transfer arm, so that the coating film can be formed over the pattern on the substrate in line, thus smoothly forming the coating film.

According to still another aspect, the present invention is a coating treatment method of forming a coating film over a pattern formed on a substrate, wherein a coating solution for forming the coating film contains a coating film forming component in a liquid state and a solvent, and the coating film forming component contains a photopolymerization initiator. The coating treatment method of the present invention includes: a coating step of applying the coating solution onto the pattern on the substrate; and an irradiation step of applying ultraviolet rays to the coating solution applied over the pattern on the substrate to activate the photopolymerization initiator to form a coating film.

In the coating treatment method of the present invention, the coating solution containing a coating film forming component in a liquid state is applied onto the pattern on the substrate. When the coating solution is applied onto the pattern on the substrate as described above, the coating solution can smoothly spread over projections and depressions of the pattern on the substrate because the coating film forming component in the liquid state contained in the coating solution has good flowability. Therefore, no bump is created in the coating film to be formed over the pattern on the substrate, thus planarizing the surface of the coating film.

Further, the coating film forming component in the liquid state contained in the coating solution applied over the pattern on the substrate has here a property of easily sublimating because it is low molecular and its molecules are not bound. When this coating film forming component is heated, the coating solution further easily sublimates. A conventional coating film is formed by curing a coating solution by heating it, so that if a coating solution is used which has a coating film forming component in the liquid state, the coating solution sublimates when the coating solution is cured. With the coating treatment method of the present invention, however, the ultraviolet rays are applied to the coating solution applied over the pattern on the substrate to activate the photopolymerization initiator contained in the coating film forming component in the coating solution to thereby cure the coating solution in order to form a coating film over the pattern on the substrate, thereby eliminating the necessity to heat the coating solution or to heat the coating solution more than necessary, so that the sublimation of the coating solution can be further suppressed as compared to the prior art. In addition, when the ultraviolet rays are applied to the photopolymerization initiator, the photopolymerization initiator can be activated in a very short time to cure the coating solution in a short time. The activation of the photopolymerization initiator in a short time also contributes to the suppression of the sublimation of the coating solution. Since the sublimation of the coating solution can be suppressed as described above, the reduction in film thickness of the coating film to be formed can be suppressed.

A time period from when the coating step is completed to when the irradiation step is started may be controlled to be within a predetermined time period. This time period can be set, for example, to a time period within which the sublimation amount of the applied coating solution falls within an allowable range when the substrate above which the coating solution has been applied is left stand. The time period is controlled as described above, so that even if the coating solution sublimates after the coating step is completed before the irradiation step is started, the reduction in film thickness of the coating film to be formed can be suppressed to fall within the allowable range.

A time period from when the coating solution is applied in the coating step to when the ultraviolet rays are applied in the irradiation step may be controlled to be constant in an entire region within the plane of the substrate. This ensures that the sublimation amount of the applied coating solution can be made constant within the entire region within the plane of the substrate above which the coating solution has been applied, thereby uniforming the film thickness of the coating film to be formed.

The application of the ultraviolet rays may be performed for the coating solution on a region of the substrate immediately after the coating solution is applied onto the region. Thereby, the coating solution applied over the pattern on the substrate is cured by application of the ultraviolet rays immediately after being applied to the substrate, whereby the time period from the application of the coating solution to the application of the ultraviolet rays can be made a very short time, so that the sublimation of the coating solution can be suppressed.

Both or one of the coating step and the irradiation step may be performed with an atmosphere around the substrate being cooled. This can cool the coating solution applied over the pattern on the substrate to further suppress the sublimation of the coating solution.

The method may include, after the coating step and before the irradiation step, a heating step of heating an atmosphere around the substrate for a predetermined time to sublimate the coating solution applied over the pattern on the substrate until the coating solution has a predetermined thickness.

Thereby, when the coating solution is applied onto the pattern on the substrate and the thickness of the applied coating solution is then larger than a predetermined thickness, the atmosphere around the substrate can be heated for a predetermined time to sublimate the coating solution over the pattern on the substrate, thereby making the thickness of the coating solution to a predetermined thickness. As a result, a coating film with a predetermined film thickness can be formed. Note that though the film thickness of the coating film can be controlled by the heating temperature and time as described above, a large variation in film thickness may be controlled by the temperature and a small variation in film thickness may be controlled by the time.

Heating the atmosphere around the substrate for a predetermined time as described above can also sublimate all the coating solution applied over the surface of the pattern except the recessed portions of the pattern. In other words, the film thickness of the coating film formed on the pattern is made zero so that the coating solution is filled and cured only in the recessed portions of the pattern to thereby eliminate the projections and depressions of the pattern, thereby planarizing the upper surface of the pattern. Conventionally, after a coating film is formed, a so-called etch-back process of removing the coating film, for example, by etching the coating film on the pattern as unnecessary may be performed, but the present invention can omit such etch-back process to improve the throughput of the substrate treatment.

The method may include, after the irradiation step, a heating step of heating an atmosphere around the substrate for a predetermined time to sublimate the coating film formed over the pattern on the substrate. For example, if the film thickness of the resist film formed on the coating film over the pattern on the substrate is nonuniform or the pattern of the resist film is not a desired one, so-called rework processing of stripping the resist film and the coating film and then forming again a coating film and a resist film over the pattern on the substrate can be performed. The removal of the resist film and the coating film in the rework processing has been performed by applying O₂ plasma or N₂/H₂ plasma thereto. However, when the application of O₂ plasma or the like is performed as in the prior art, the pattern on the substrate may be damaged by O₂ plasma or the like. In such rework processing, heating the atmosphere around the substrate can sublimate and strip the coating film, thereby reducing or avoiding the damage to the pattern on the substrate. Further, this can improve the decrease in yield in the rework processing.

According to yet another aspect, the present invention provides a readable computer storage medium storing a program running on a computer of a control unit for controlling a coating treatment apparatus or a substrate treatment system to cause the coating treatment apparatus or the substrate treatment system to perform the above-described coating treatment method.

According to the present invention, when forming a coating film over a predetermined pattern formed on a substrate, the surface of the coating film can be planarized and the sublimation of the coating solution can be suppressed to suppress the reduction in film thickness of the coating film.

### BRIEF DESCRIPTION OF THE DRAWINGS

FIG. 1 is a plan view schematically showing the outline of a configuration of a coating and developing treatment system incorporating a coating treatment apparatus according to an embodiment;

FIG. 2 is a front view of the coating and developing treatment system according to the embodiment;

FIG. 3 is a rear view of the coating and developing treatment system according to the embodiment;

FIG. 4 is a longitudinal sectional view schematically showing the outline of a configuration of the coating treatment apparatus according to the embodiment;

FIG. 5 is a plan view schematically showing the outline of a configuration of the coating treatment apparatus according to the embodiment;

FIG. 6 is an explanatory view showing states of the coating film formed over a pattern on a wafer according to the embodiment, (a) showing a state before ultraviolet rays are applied, and (b) showing a state after the ultraviolet rays are applied;

FIG. 7 is a longitudinal sectional view schematically showing the outline of a configuration of the coating treatment apparatus according to another embodiment;

FIG. 8 is a longitudinal sectional view schematically showing the outline of a configuration of the coating treatment apparatus according to another embodiment;

FIG. 9 is a longitudinal sectional view schematically showing the outline of a configuration of the coating treatment apparatus according to another embodiment;

FIG. 10 is a perspective view in a case where an irradiation unit is provided beside a coating nozzle;

FIG. 11 is a perspective view of a coating nozzle having a discharge port in a slit form;

FIG. 12 is a longitudinal sectional view schematically showing the outline of a configuration of a coating treatment apparatus according to another embodiment;

FIG. 13 is a plan view schematically showing the outline of a configuration of the coating treatment apparatus according to the other embodiment;

FIG. 14 is a plan view schematically showing the outline of a configuration of a coating treatment apparatus according to another embodiment;

FIG. 15 is a perspective view in a case where the irradiation unit is provided beside the coating nozzle;

FIG. 16 is a plan view schematically showing the outline of a configuration of the coating treatment apparatus according to another embodiment;

FIG. 17 is a plan view schematically showing the outline of a configuration of the coating treatment apparatus according to another embodiment;

FIG. 18 is a longitudinal sectional view schematically showing the outline of a configuration of a coating treatment apparatus and a transfer unit according to another embodiment;

FIG. 19 is a longitudinal sectional view schematically showing the outline of a configuration of a coating treatment apparatus according to another embodiment;

FIG. 20 is a plan view schematically showing the outline of a configuration of the coating treatment apparatus according to the other embodiment;

FIG. 21 is a flowchart showing a method of forming a coating film according to another embodiment;

FIG. 22 is a longitudinal sectional view schematically showing the outline of a configuration of a coating treatment apparatus according to another embodiment;

FIG. 23 is an explanatory view of an operation schematically showing states of a coating solution until a coating film is formed over a pattern on a wafer according to another embodiment, (a) showing a state after the coating solution is applied, (b) showing a state where the coating solution is then heated, and (c) showing a state where ultraviolet rays are applied after the heating;

FIG. 24 is an explanatory view of an operation schematically showing states of a coating solution until a coating film is formed over a pattern on a wafer according to another embodiment, (a) showing a state where all the coating solution is sublimated by heating, and (b) showing a state where a coating solution is then filled and cured;

FIG. 25 is an explanatory view of an operation schematically showing the appearance where a coating film and a resist film over a pattern on a wafer are stripped in rework processing, (a) showing a state where the resist film and an anti-reflection film are stripped by application of plasma, (b) showing a state where an atmosphere around the wafer is heated, and (c) showing a state where the coating film is stripped by sublimation;

FIG. 26 is an explanatory view showing the appearance of ashing the coating film over the pattern on the wafer, (a) showing a state of heating, and (b) showing a state where the coating film is stripped by sublimation;

FIG. 27 is a graph showing the variation with time in film thickness when the coating film over the pattern on the wafer is heated at 350° C.; and

FIG. 28 is an explanatory view showing a state where a coating film formed over a pattern on a wafer in a prior art.

### DETAILED DESCRIPTION OF THE INVENTION

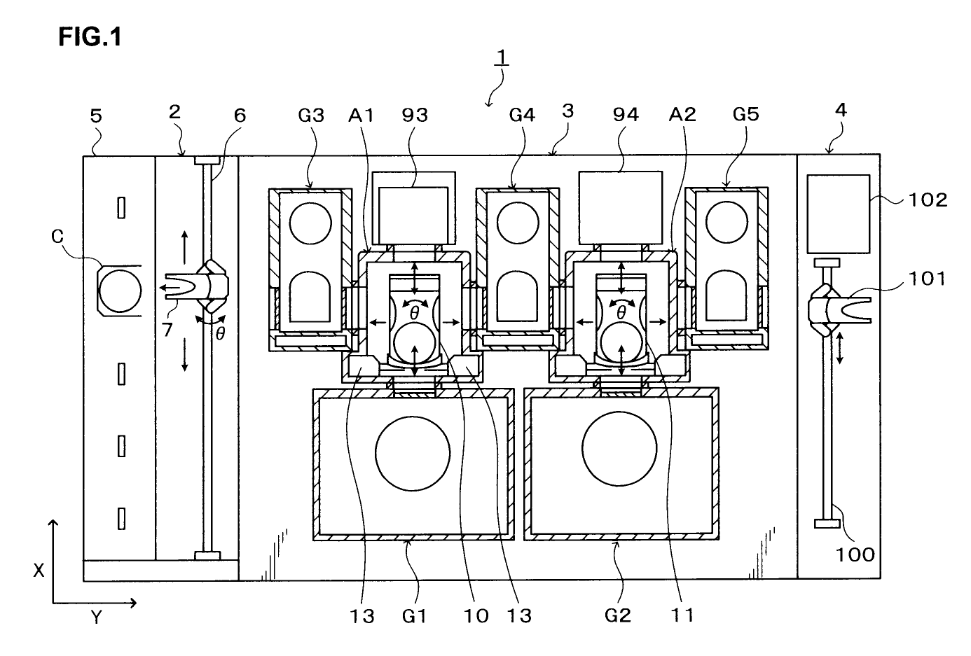

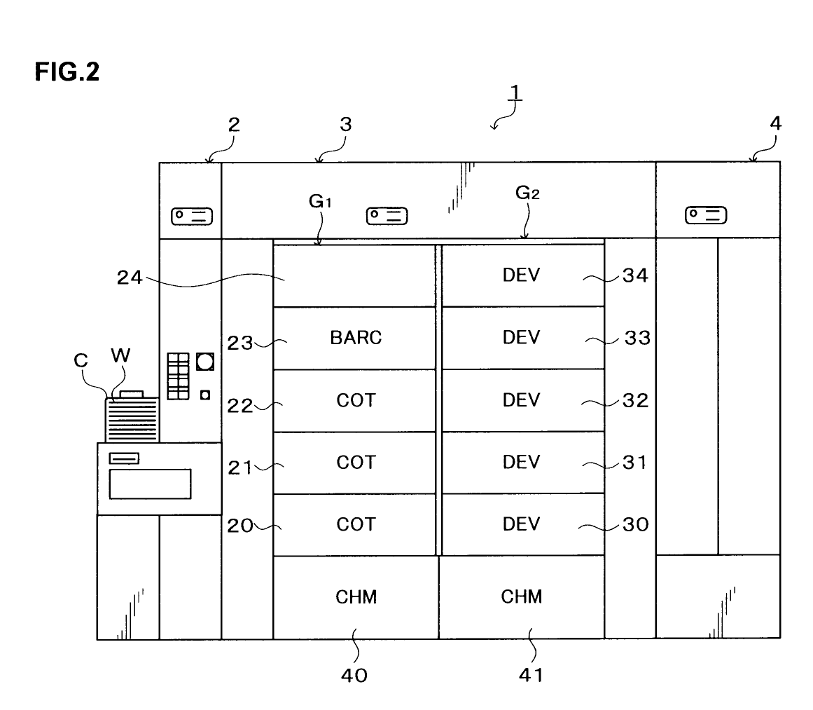

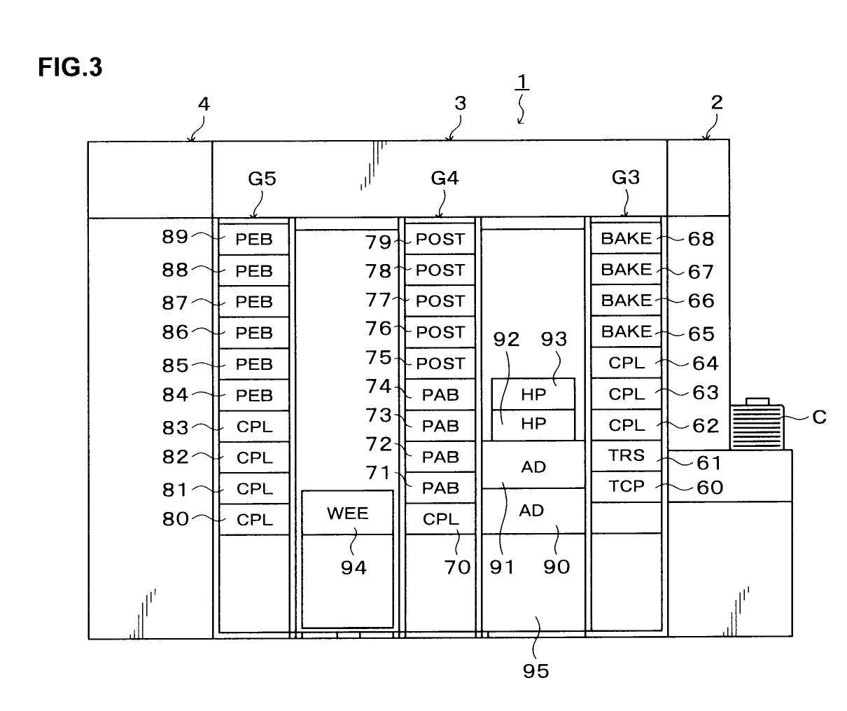

Hereinafter, preferred embodiments of the present invention will be described. FIG. 1 is a plan view showing the outline of a configuration of a coating and developing treatment system 1 as a substrate treatment system incorporating a coating treatment apparatus according to the embodiment, FIG. 2 is a front view of the coating and developing treatment system 1, and FIG. 3 is a rear view of the coating and developing treatment system 1.

The coating and developing treatment system 1 has, as shown in FIG. 1, a configuration in which, for example, a cassette station 2 for transferring 25 wafers W per cassette as a unit from/to the outside into/from the coating and developing treatment system 1 and transferring the wafers W into/out of a cassette C; a processing station 3 including a plurality of various kinds of processing and treatment units, which are multi-tiered, for performing predetermined processing or treatment in a manner of single wafer processing in the photolithography process; and an interface section 4 for delivering the wafers W to/from an aligner (not shown) provided adjacent to the processing station 3, are integrally connected together.

In the cassette station 2, a cassette mounting table 5 is provided and configured such that a plurality of cassettes C can be mounted thereon in a line in an X-direction (a top-to-bottom direction in FIG. 1). In the cassette station 2, a wafer transfer body 7 is provided which is movable in the X-direction on a transfer path 6. The wafer transfer body 7 is also movable in a wafer-arrangement direction of the wafers W housed in the cassette C (a Z-direction; the vertical direction), and thus can selectively access the wafer W in each of the cassettes C arranged in the X-direction.

The wafer transfer body 7 is rotatable in a θ-direction around a Z-axis, and can access a temperature regulating unit 60 and a transition unit 61 for passing the wafer W included in a later-described third processing unit group G3 on the processing station 3 side.

The processing station 3 adjacent to the cassette station 2 includes, for example, five processing unit groups G1 to G5 in each of which a plurality of processing and treatment units are multi-tiered. On the side of the negative direction in the X-direction (the downward direction in FIG. 1) in the processing station 3, the first processing unit group G1 and the second processing unit group G2 are placed in order from the cassette station 2 side.

On the side of the positive direction in the X-direction (the upward direction in FIG. 1) in the processing station 3, the third processing unit group G3, the fourth processing unit group G4, and the fifth processing unit group G5 are placed in order from the cassette station 2 side. Between the third processing unit group G3 and the fourth processing unit group G4, a first transfer unit A1 is provided, and a first transfer arm 10 that supports and transfers the wafer W is provided inside the first transfer unit A1.

The first transfer arm 10 can selectively access the processing and treatment units in the first processing unit group G1, the third processing unit group G3, and the fourth processing unit group G4 and transfer the wafer W to them. Between the fourth processing unit group G4 and the fifth processing unit group G5, a second transfer unit A2 is provided, and a second transfer arm 11 that supports and transfers the wafer W is provided inside the second transfer unit A2. The second transfer arm 11 can selectively access the processing and treatment units in the second processing unit group G2, the fourth processing unit group G4, and the fifth processing unit group G5 and transfer the wafer W to them.

In the first processing unit group G1, as shown in FIG. 2, solution treatment units each for supplying a predetermined liquid to the wafer W to perform treatment, for example, resist coating units 20, 21, and 22 each applying a resist solution to the wafer W, a bottom coating unit 23 for forming an anti-reflection film that prevents reflection of light at the time of exposure processing, and a coating treatment apparatus 24 according to the present invention for forming a coating film R over a pattern P on the wafer W are five-tiered in order from the bottom. In the second processing unit group G2, solution treatment units, for example, developing treatment units 30 to 34 each for supplying a developing solution to the wafer W to develop it are five-tiered in order from the bottom. Further, chemical chambers 40 and 41 for supplying various kinds of treatment solutions to the solution treatment units in the processing unit groups G1 and G2 are provided at the lowermost tiers of the first processing unit group G1 and the second processing unit group G2, respectively.

As shown in FIG. 3, in the third processing unit group G3, for example, the temperature regulating unit 60, the transition unit 61, high-precision temperature regulating units 62 to 64 each for regulating the temperature of the wafer W under a high precision temperature control, and high-temperature thermal processing units 65 to 68 each for heat-processing the wafer W at a high temperature, are nine-tiered in order from the bottom.

In the fourth processing unit group G4, for example, a high-precision temperature regulating unit 70, pre-baking units 71 to 74 each for heat-processing the wafer W after resist coating treatment, and post-baking units 75 to 79 each for heat-processing the wafer W after developing treatment, are ten-tiered in order from the bottom.

In the fifth processing unit group G5, a plurality of thermal processing units each for thermally processing the wafer W, for example, high-precision temperature regulating units 80 to 83, and post-exposure baking units 84 to 89, are ten-tiered in order from the bottom.

As shown in FIG. 1, on the positive direction side in the X-direction to the first transfer unit A1, a plurality of processing and treatment units are arranged, for example, adhesion units 90 and 91 each for performing hydrophobic treatment on the wafer W and heating units 92 and 93 each for heating the wafer W being four-tiered in order from the bottom as shown in FIG. 3. As shown in FIG. 1, on the positive side in the X-direction to the second transfer unit A2, for example, an edge exposure unit 94 is disposed which selectively exposes only the edge portion of the wafer W to light.

In the interface section 4, for example, a wafer transfer body 101 moving on a transfer path 100 extending in the X-direction and a buffer cassette 102 are provided as shown in FIG. 1. The wafer transfer body 101 is movable in the Z-direction and also rotatable in the θ-direction, and thus can access the aligner (not shown) adjacent to the interface section 4, the buffer cassette 102, and the fifth processing unit group G5 and transfer the wafer W to them.

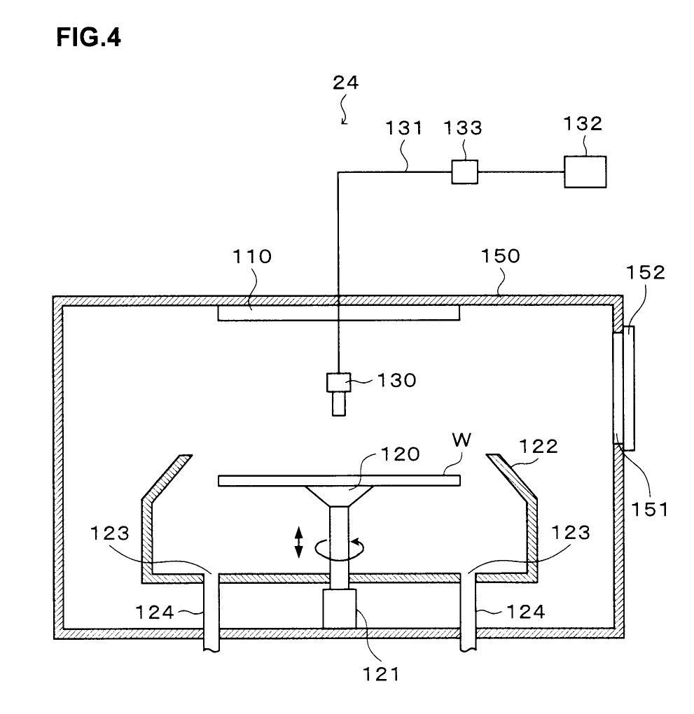

Next, the configuration of the above-described coating treatment apparatus 24 will be described based on FIG. 4. The coating treatment apparatus 24 has a treatment container 150. On one side surface of the treatment container 150, a transfer-in/out port 151 for the wafer W is provided in a surface facing a transfer-in region for the first transfer arm 10 being a transfer means for the wafer W, and an opening/closing shutter 152 is provided at the transfer-in/out port 151.

Inside the treatment container 150, a spin chuck 120 as a substrate holding mechanism is provided which holds the wafer W on its upper surface by vacuum suction. The spin chuck 120 can rotate around the vertical axis and raise and lower by means of a rotary drive unit 121 including a motor and the like.

Around the spin chuck 120, a cup body 122 is provided. The cup body 122 has an opening portion formed in its surface which is larger than the wafer W to allow the spin chuck 120 to rise and lower therethrough. The bottom portion of the cup body 122 is provided with a drain port 123 for draining the coating solution dripping down, and a drain pipe 124 is connected to the drain port 123 is connected.

Above the spin chuck 120, a coating nozzle 130 is located for applying a coating solution onto the central portion of the front surface of the wafer W. The coating nozzle 130 is connected to a coating solution supply source 132 for supplying the coating solution via a coating solution supply pipe 131. The coating solution supply pipe 131 is provided with a supply controller 133 including a valve, a flow control unit, and so on. Used as the coating solution supplied from the coating solution supply source 132 is, for example, XUV (a product from Nissan Chemical Industries, LTD.), and the coating solution contains a coating film forming component in the liquid state and a solvent. The coating film forming component includes, for example, a photopolymerization initiator such as iodonium salt, epoxy resin, polypropylene glycol monomethyl ether, polypropylene glycol monoethyl acetate, and so on. As the solvent, for example, thinner is used.

In an upper portion of the treatment container 150, an irradiation unit 110 is provided which applies ultraviolet rays to the wafer W on the spin chuck 120. The irradiation unit 110 can apply the ultraviolet rays to the entire surface of the wafer W.

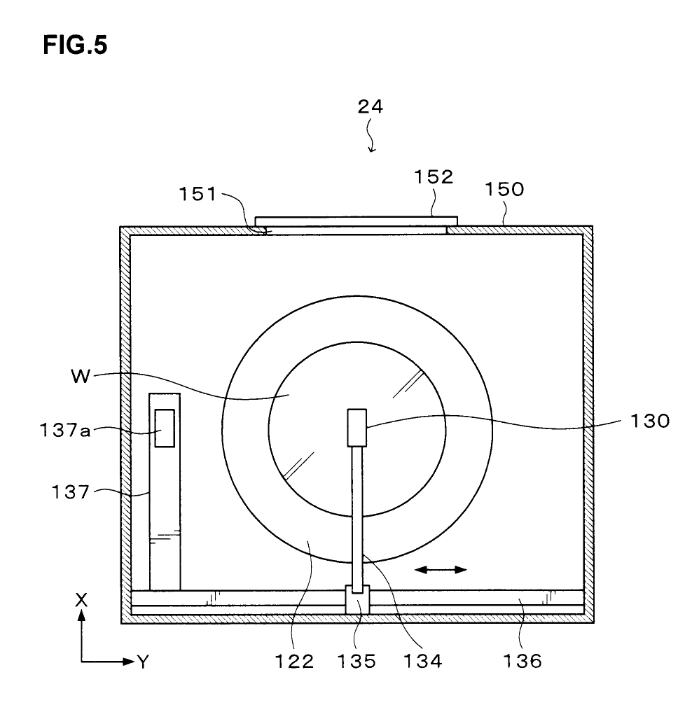

The coating nozzle 130 is connected to a moving mechanism 135 via an arm 134 as shown in FIG. 5. The arm 134 can be moved by the moving mechanism 135 along a guide rail 136 provided along the length direction (a Y-direction) of the treatment container 150, from a waiting region 137 provided outside on the side of one end of the cup body 122 (the left side in FIG. 5) toward the other end side and vertically moved. The waiting region 137 is configured to be able to accommodate the coating nozzle 130 and includes a cleaning unit 137a which can clean the tip end portion of the coating nozzle 130.

The coating and developing treatment system 1 incorporating the coating treatment apparatus 24 according to this embodiment is configured as described above, and the wafer treatment performed in this coating and developing treatment system 1 will be described next.

First of all, one wafer W on which a predetermined pattern has been formed is taken out of the cassette C on the cassette mounting table 5 by the wafer transfer body 7 and transferred to the temperature regulating unit 60 in the third processing unit group G3. The wafer W transferred to the temperature regulating unit 60 is temperature-regulated to a predetermined temperature and then transferred to the coating treatment apparatus 24 according to the present invention.

The wafer W is transferred into the treatment container 150 through the transfer-in/out port 151 by the first transfer arm 10 and moved to above the spin chuck 120. The spin chuck 120 is then raised, and the wafer W is passed onto the spin chuck 120 from the first transfer arm 10. The wafer W is sucked and horizontally held on the spin chuck 120 and then lowered to a predetermined position.

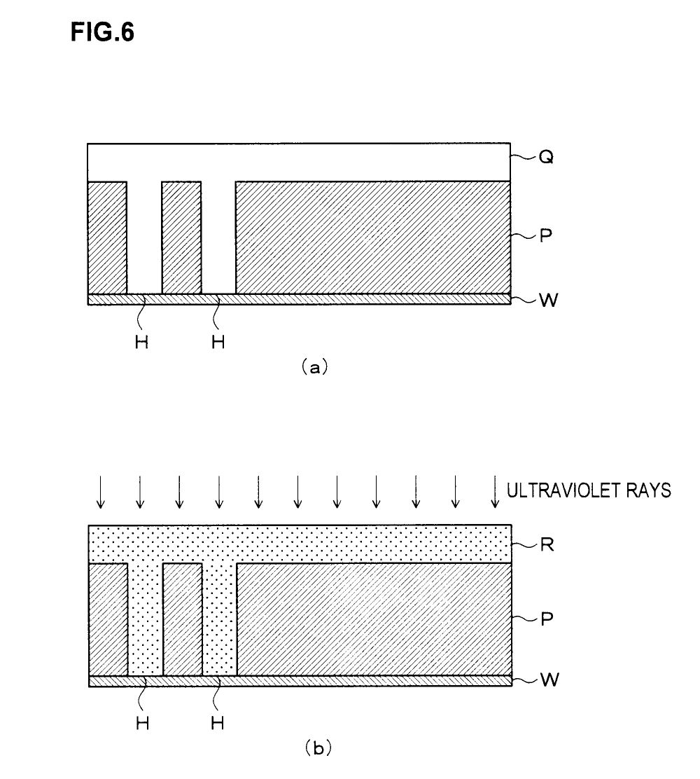

The wafer W is then rotated at, for example, a rotation speed of 500 rpm by the rotary drive unit 121, and the coating nozzle 130 is moved to above the central portion of the wafer W. A coating solution Q is discharged, for example, for two seconds from the coating nozzle 130 onto the central portion of the wafer W as shown at (a) in FIG. 6, and the rotation is accelerated to, for example, about 1500 rpm and the wafer W is rotated for 15 seconds. By the centrifugal force generated from the rotation of the wafer W, the coating solution Q is spread over the pattern P on the wafer W. The coating nozzle 130 is then moved from above the central portion of the wafer W to the waiting region 137.

After the coating solution Q is spread over the entire surface of the pattern P on the wafer W, the wafer W is raised to a predetermined position by the spin chuck 120. From the irradiation unit 110 onto the coating solution Q applied over the pattern P on the wafer W, ultraviolet rays having a wavelength of, for example, 222 nm and an energy of 7 mW/cm² are applied, for example, for 2 sec/cm². The applied ultraviolet rays activate the photopolymerization initiator contained in the coating solution Q to cure the coating solution Q. Thus, a coating film R which is made by curing the coating solution Q is formed over the pattern P on the wafer W as shown at (b) in FIG. 6. The coating film R is formed in a film thickness of, for example, 100 nm to 300 nm.

After formation of the coating film R over the pattern O on the wafer W, the wafer W is transferred by the first transfer arm 10 into the bottom coating unit 23, where an anti-reflection film is formed. The wafer W above which the anti-reflection film has been formed is transferred by the first transfer arm 10 to the heating unit 92, the high-temperature thermal processing unit 65, and the high-precision temperature regulating unit 70 in sequence so that predetermined processing is performed in each of the units. Thereafter, the wafer W is transferred to the resist coating unit 20.

The wafer W above which the resist film has been formed in the resist coating unit 20 is transferred by the first transfer arm 10 to the pre-baking unit 71 and subjected to heating processing, and subsequently transferred by the second transfer arm 11 to the edge exposure unit 94 and the high-precision temperature regulating unit 83 in sequence so that the wafer W is subjected to predetermined processing in each of the units. Thereafter, the wafer W is transferred by the wafer transfer body 101 in the interface section 4 to the aligner (not shown) so that the resist film above the wafer W is exposed to light under a predetermined pattern. The wafer W for which exposure processing has been finished is transferred by the wafer transfer body 101, for example, to the post-exposure baking unit 84, where the wafer W is subjected to predetermined processing.

After completion of the thermal processing in the post-exposure baking unit 84, the wafer W is transferred by the second transfer arm 11 to the high-precision temperature regulating unit 81, where the wafer W is temperature-regulated, and then transferred to the developing treatment unit 30, where developing treatment is performed on the wafer W so that a pattern is formed in the resist film. The wafer W is then transferred by the second transfer arm 11 to the post-baking unit 75, where the wafer W is subjected to heating processing, and subsequently transferred to the high-precision temperature regulating unit 63, where the wafer W is temperature-regulated. The wafer W is then transferred by the first transfer arm 10 to the transition unit 61, and returned by the wafer transfer body 7 to the cassette C, with which a series of photolithography process ends.

According to the above embodiment, after the coating solution Q is applied over the pattern P on the wafer W, the coating solution Q can smoothly spread over projections and depressions of the pattern P on the wafer W because the coating film forming component in the liquid state contained in the coating solution Q has good flowability. Accordingly, the surface of the coating film R to be formed over the pattern P on the wafer W can be planarized as shown at (b) in FIG. 6.

Application of the ultraviolet rays from the irradiation unit 110 to the coating solution Q applied over the pattern P on the wafer W can cure the coating solution Q to form the coating film R over the pattern P on the wafer W, thus eliminating heating of the coating solution Q in forming the coating film R as in the prior art and preventing sublimation of the coating solution Q that is likely to sublimate by heating. This can prevent reduction in film thickness of the coating film R to be formed.

Further, the irradiation unit 110 is provided in the upper portion in the treatment container 150 and applies ultraviolet rays to the wafer W on the spin chuck 120, so that the application of the coating solution Q and the application of the ultraviolet rays to the wafer W can be performed with the wafer W being housed in the treatment container 150. Accordingly, the processing from the application of the coating solution Q to the application of the ultraviolet rays can be consecutively performed, thereby accordingly reducing the processing time.

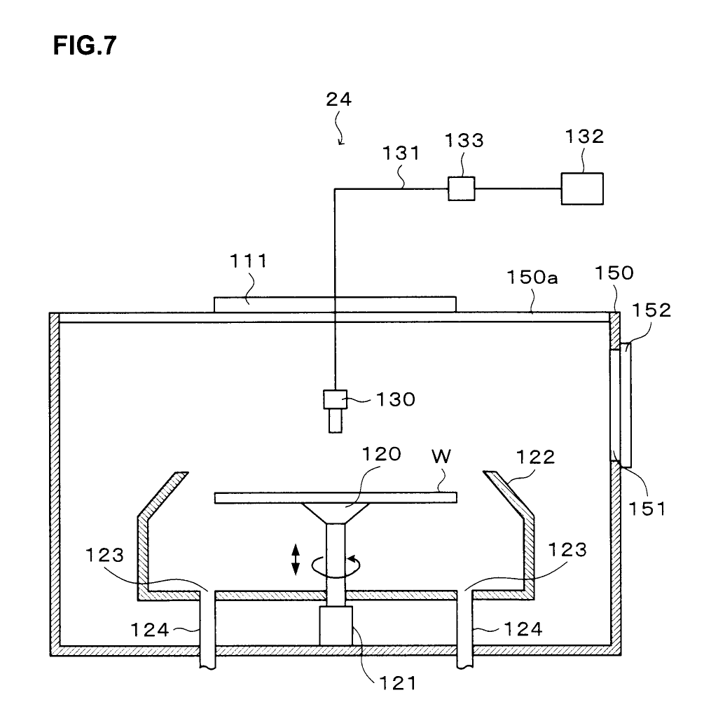

Although the irradiation unit 110 described in the above embodiment is provided in the upper portion in the treatment container 150, an irradiation unit 111 may be provided outside an upper surface 150a of the treatment container 150 as shown in FIG. 7. The irradiation unit 111 is located in an orientation to be able to apply ultraviolet rays to the wafer W on the spin chuck 120, and the upper surface 150a employs, for example, a transparent and colorless glass plate which transmits the ultraviolet rays. In this case, the ultraviolet rays applied from the irradiation unit 111 can be transmitted through the upper surface 150a and applied to the coating solution Q over the pattern P on the wafer W to form a coating film R. Further, since the irradiation unit 111 is never contaminated, for example, even if the coating solution Q scatters in the treatment container 150, the frequency of maintenance of the irradiation unit 111 can be reduced.

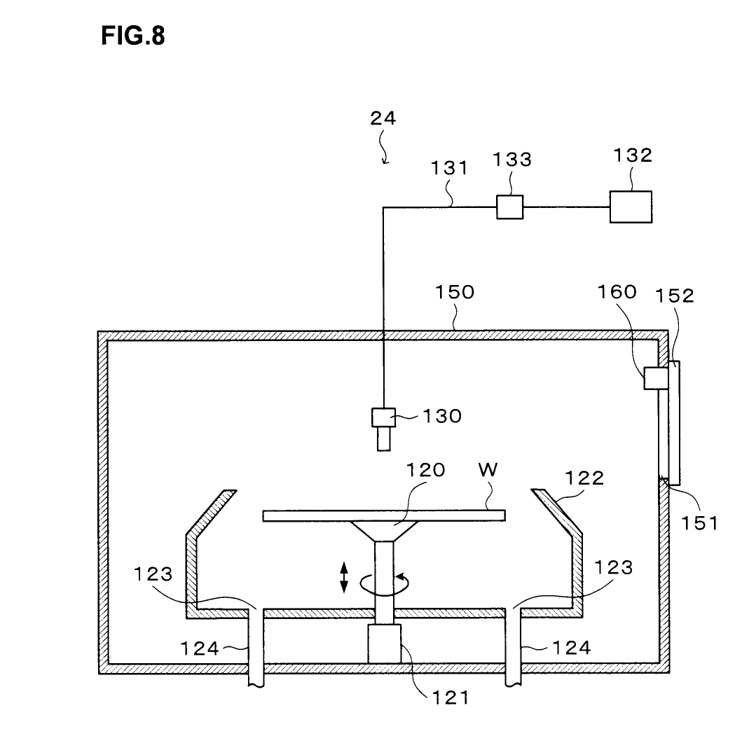

While the irradiation units 110 and 111 described in the above embodiment are provided above the spin chuck 120, an irradiation unit 160 may be provided at an upper portion of the transfer-in/out port 151 as shown in FIG. 8. In this case, after the coating solution Q is applied from the coating nozzle 130 onto the pattern P on the wafer W, the irradiation unit 160 can apply the ultraviolet rays to the coating solution Q over the pattern P on the wafer W when the wafer W is transferred by the first transfer arm 10 to the outside through the transfer-in/out port 151 of the treatment container 150. Thus, the application of the coating solution Q and the application of the ultraviolet rays can be consecutively performed for the wafer W in the treatment container 150, thereby reducing the time from the application of the coating solution Q to the application of the ultraviolet rays.

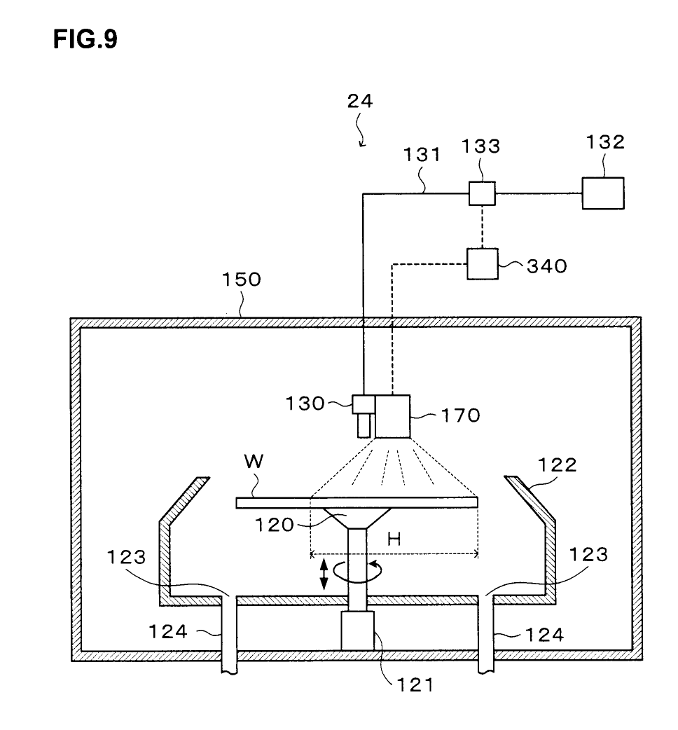

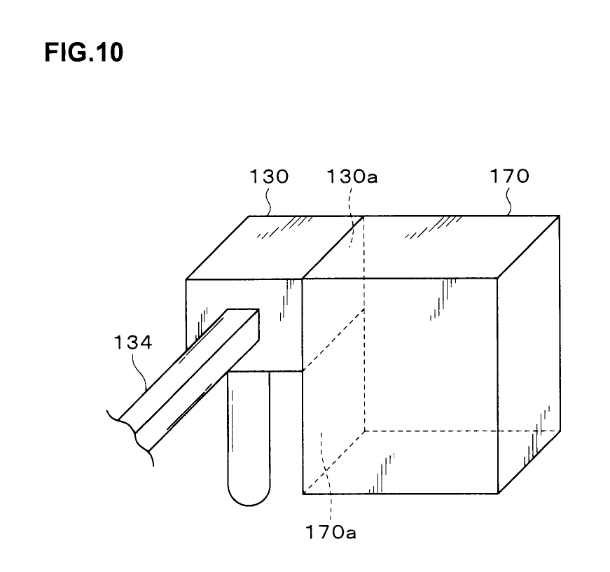

While the irradiation units 110, 111, and 160 described in the above embodiment are provided above the spin chuck 120 or at the upper portion of the transfer-in/out port 151, an irradiation unit 170 may be provided beside the coating nozzle 130 as shown in FIG. 9. The irradiation unit 170 is provided beside the coating nozzle 130 by connecting one side surface 130a of the coating nozzle 130 to one side surface 170a of the irradiation unit 170 as shown in FIG. 10. In this case, by adjusting the position in the vertical direction of the irradiation unit 170 or the position in the vertical direction of the wafer W, the ultraviolet rays are applied to the coating solution Q to the pattern P on the wafer W from the irradiation unit 170 at least within a range H from the center of the wafer W to the end portion of the wafer W as shown in FIG. 9.

The coating treatment apparatus 24 may be provided with a control unit 340 that controls the application of the ultraviolet rays from the irradiation unit 170 or the application of the coating solution Q by the supply controller 133 or the like. The control unit 340 conducts control such that the irradiation unit 170 applies the ultraviolet rays to the coating solution Q on a region on the wafer W immediately after the coating solution Q is applied from the coating nozzle 130 to the region.

In this case, since the irradiation unit 170 applies the ultraviolet rays to the wafer W rotated by the spin chuck 120, the coating solution Q on the entire surface of the wafer W can be cured only by applying the ultraviolet rays at least to the range H to form the coating film R.

Further, the coating solution Q applied over the pattern P on the wafer W is cured by application of the ultraviolet rays immediately after the coating solution Q is applied to the wafer W by the control of the control unit 340, thus preventing sublimation of the coating solution Q.

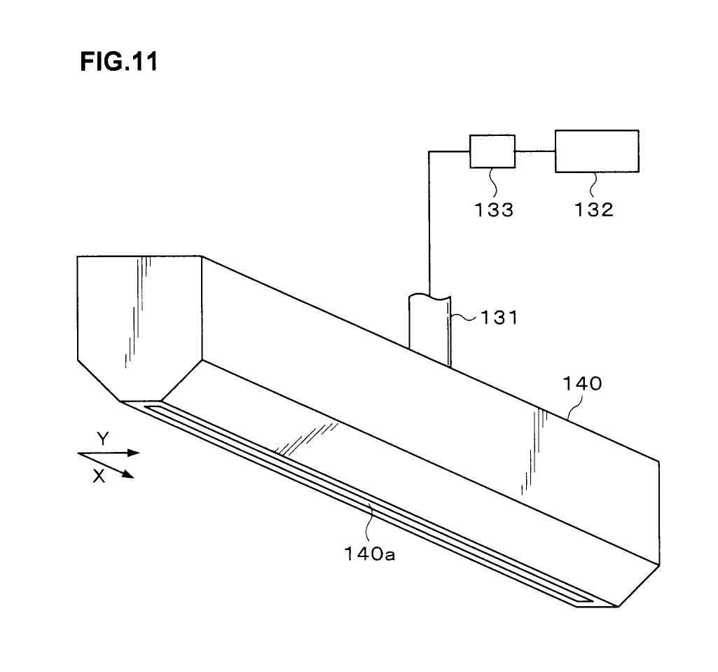

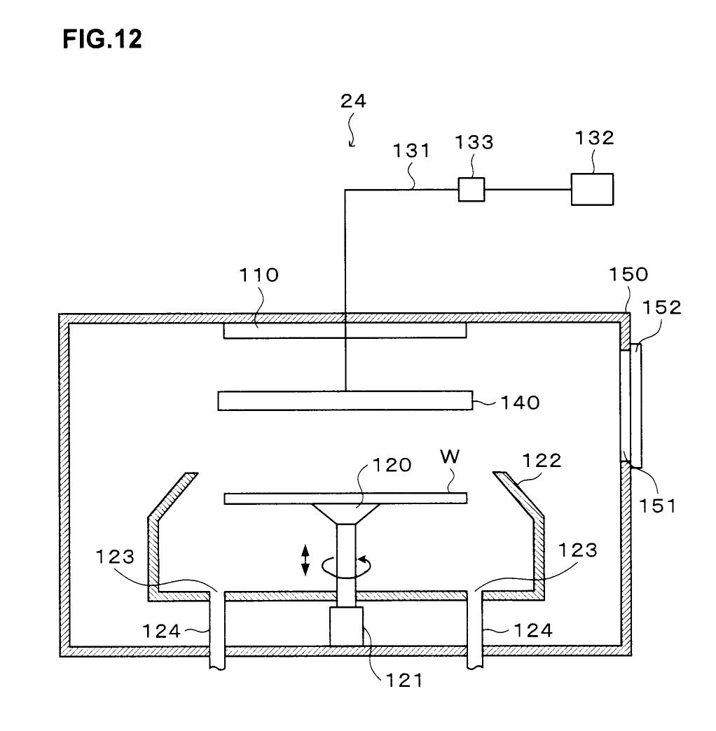

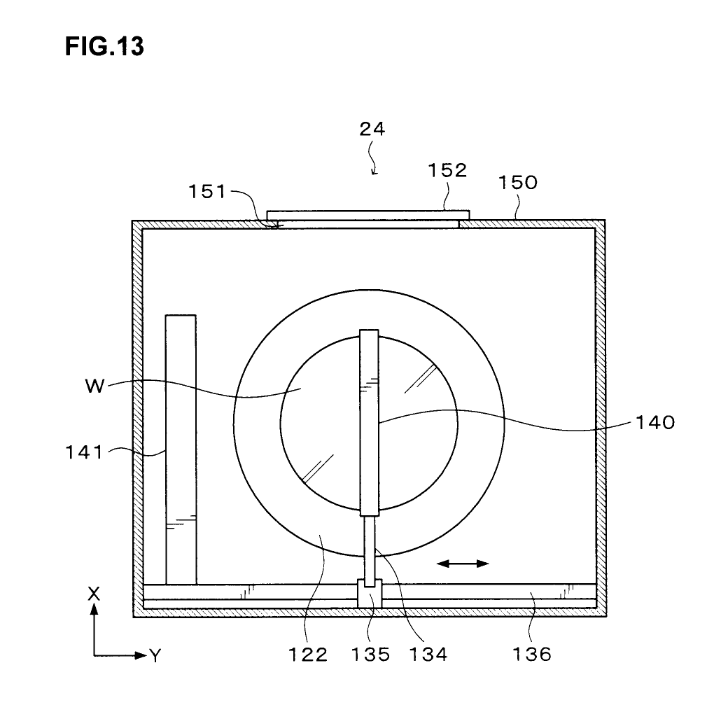

In place of the coating nozzle 130 described in the above embodiment, a coating nozzle 140 may be used which has a discharge port 140a in a slit form extending in the X-direction as shown in FIG. 11. The coating nozzle 140 is formed, as shown in FIG. 12 and FIG. 13, to be longer than the width in the X-direction of the wafer W. The coating nozzle 140 can be moved along a guide rail 136 from a waiting region 141 provided outside one end side of the cup body 122 (the left side in FIG. 13) toward the other end side. The waiting region 141 is configured to be able to accommodate the coating nozzle 140. Note that, as the irradiation unit, any of the above-described irradiation units 110, 111, and 160 may be used. Even in this case, the coating film R can be formed by applying the coating solution Q onto the pattern P on the wafer W from the coating nozzle 140 and then applying the ultraviolet rays to the coating solution Q over the pattern P on the wafer W by any one of the irradiation units 110, 111, and 160.

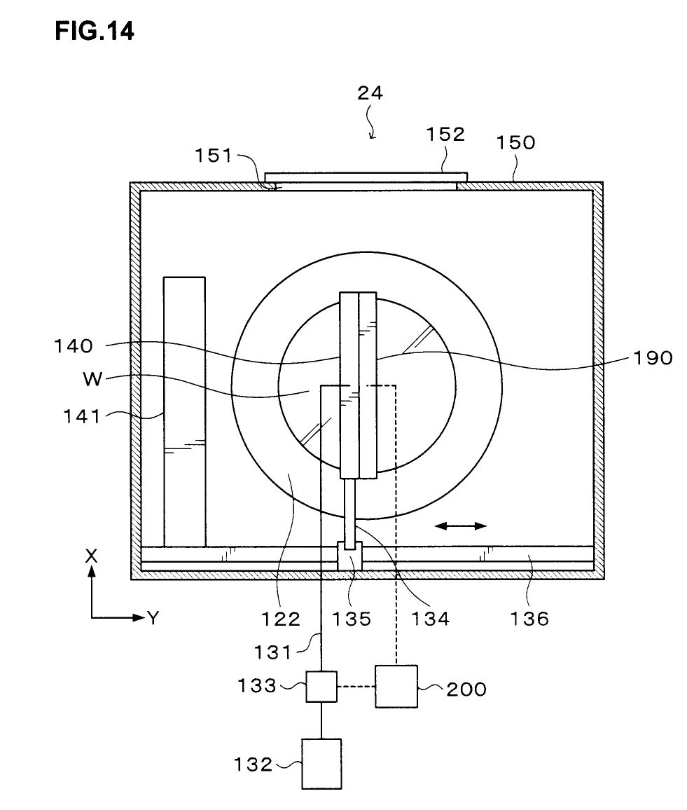

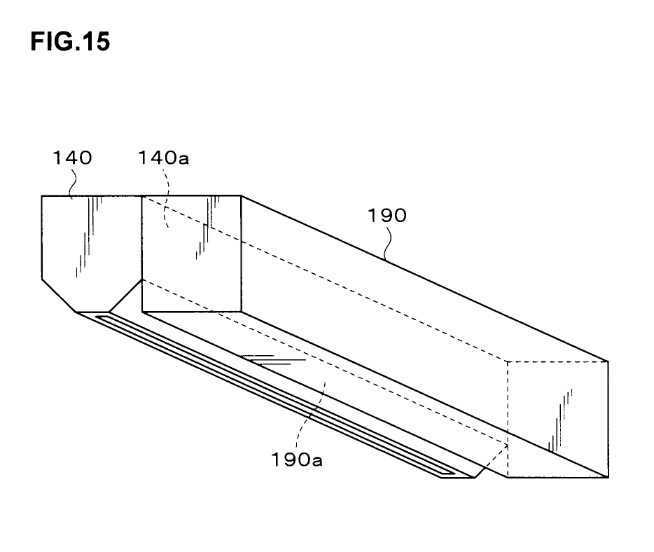

When the coating nozzle 140 described in the above embodiment is used, an irradiation unit 190 may be provided beside the coating nozzle 140 which extends in the direction of the width of the wafer W parallel to the coating nozzle 140 as shown in FIG. 14. The irradiation unit 190 is provided beside the coating nozzle 140 by connecting one side surface 140a of the coating nozzle 140 to one side surface 190a of the irradiation unit 190 as shown in FIG. 15.

The coating treatment apparatus 24 may be provided with a control unit 200 that controls the application of the ultraviolet rays from the irradiation unit 190 or the application of the coating solution Q by a supply controller 143 or the like. The control unit 200 conducts control such that the irradiation unit 190 applies the ultraviolet rays to the coating solution Q on a region on the wafer W immediately after the coating solution Q is applied from the coating nozzle 140 to the region.

In this case, the coating solution Q applied over the pattern P on the wafer W is cured by application of the ultraviolet rays immediately after the coating solution Q is applied to the wafer W by the control of the control unit 200, thus preventing sublimation of the coating solution. Q. Further, since the coating nozzle 140 and the irradiation unit 190 are moved in synchronization, the time period from when the coating solution Q is applied to when the ultraviolet rays are applied can be controlled to be constant within the entire region within the plane of the wafer W, thereby uniforming the film thickness of the coating film R to be formed over the pattern on the wafer W.

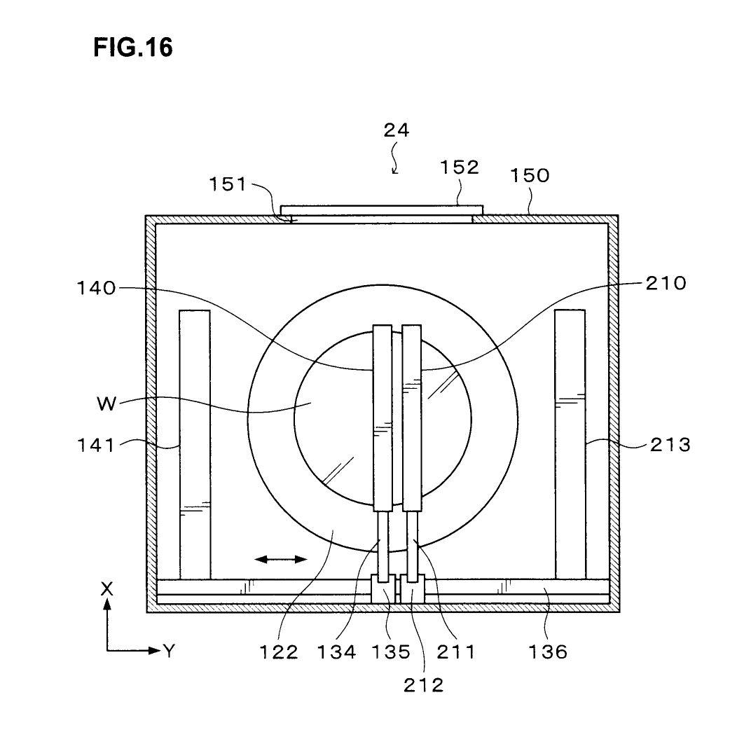

While the irradiation unit 190 is provided beside the coating nozzle 140 in the above embodiment, an irradiation unit 210 may be provided independent from the coating nozzle 140 as shown in FIG. 16. The irradiation unit 210 has an arm 211 and a moving mechanism 212 which are independent from the arm 134 and the moving mechanism 135 of the coating nozzle 140. The irradiation unit 210 can be moved by the moving mechanism 212 along the guide rail 136 from a waiting region 213 provided outside one end side of the cup body 122 (the right side in FIG. 16) toward the other end side and moved in the vertical direction.

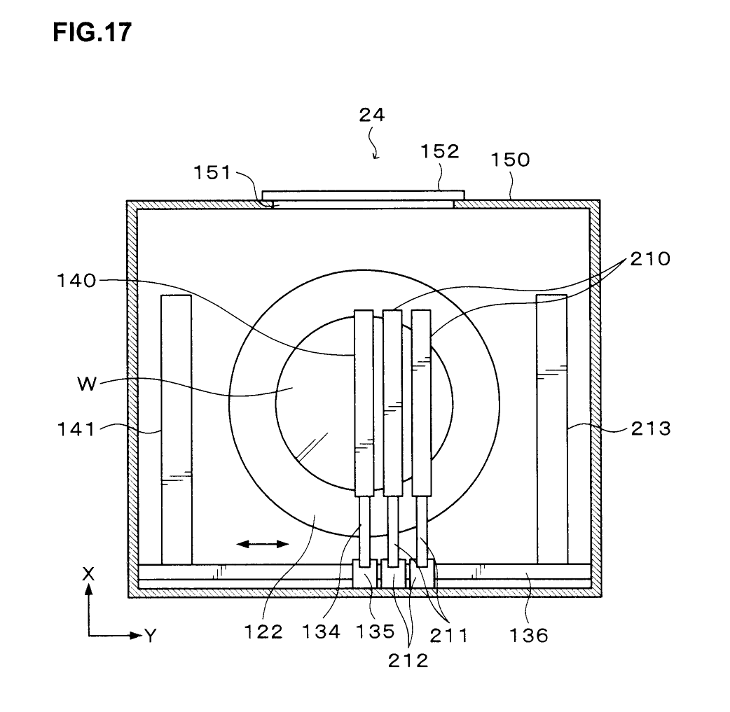

The waiting region 213 is configured to be able to accommodate the irradiation unit 210. In this case, since the irradiation unit 210 is moved independent from the coating nozzle 140, the time period from when the coating solution Q is applied to when the ultraviolet rays are applied can be controlled to be uniform within the entire region within the plane of the wafer W. Note that a plurality of the irradiation units 210, the arms 211, and the moving mechanisms 212 may be provided as shown in FIG. 17. Provision of the plurality of irradiation units 210 can further reduce the time period for application of the ultraviolet rays to the coating solution Q.

Note that though the above coating treatment apparatus 24 is provided inside the coating and developing treatment system 1, the coating treatment apparatus 24 may be independently provided outside the coating and developing treatment system 1.

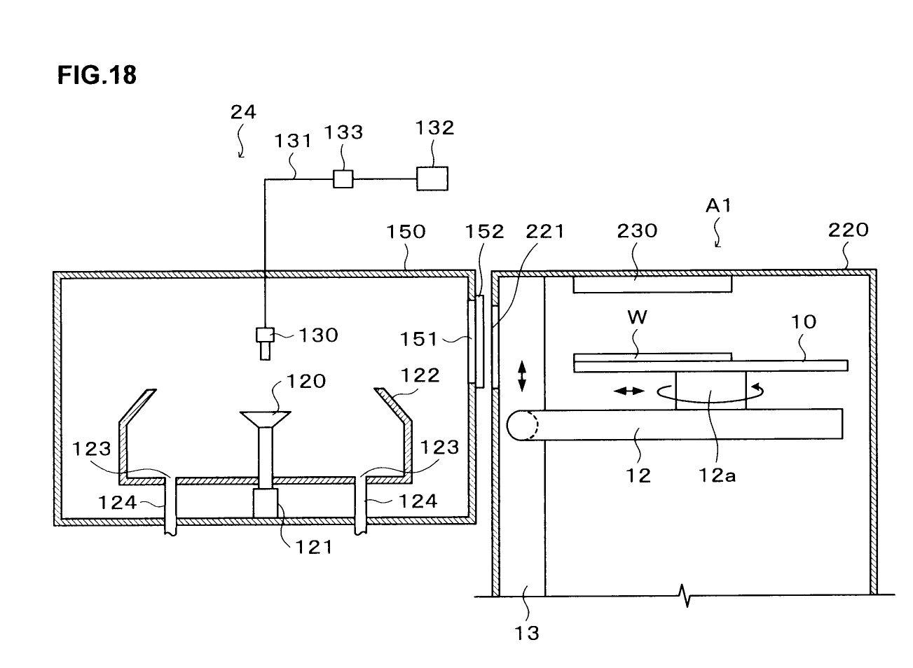

While the irradiation units 110, 111, 160, 190, and 210 are provided in the coating treatment apparatus 24 in the above embodiment, an irradiation unit 230 may be provided in the first transfer unit A1 as shown in FIG. 18. The first transfer unit A1 has a casing 220, and a transfer-in/out port 221 for the wafer W is formed in one side surface of the casing 220 on the side of the coating treatment apparatus 24. Poles 13 are provided in the vertical direction as shown in FIG. 1 in the casing 220 on the side of the first processing unit group G1 and the second processing unit group G2, and a raising and lowering mechanism (not shown) for raising and lowering the first transfer arm 10 is embedded in one of the poles 13. Between the poles 13, a support unit 12 is provided as shown in FIG. 18, and both end portions of the support unit 12 are connected to the poles 13. On the support unit 12, a rotary shaft 12A is provided which supports the first transfer arm 10. In the support unit 12, a motor (not shown) is embedded for rotating and horizontally moving the shaft 12A so that the first transfer arm 10 is freely rotatable and also movable in the horizontal direction. Further, in an upper portion in the casing 220, an irradiation unit 230 is provided which applies ultraviolet rays to the wafer W supported by the first transfer arm 10.

In this case, after the coating solution Q is applied onto the pattern P on the wafer W in the coating treatment apparatus 24, the wafer W is transferred by the first transfer arm 10 into the first transfer unit A1 through the transfer-in/out port 221. With the wafer W being supported by the first transfer arm 10, the ultraviolet rays are supplied from the irradiation unit 230 onto the coating solution Q over the pattern P on the wafer W to cure the coating solution Q. As a result, the coating film R is can be formed over the pattern P on the wafer W in line.

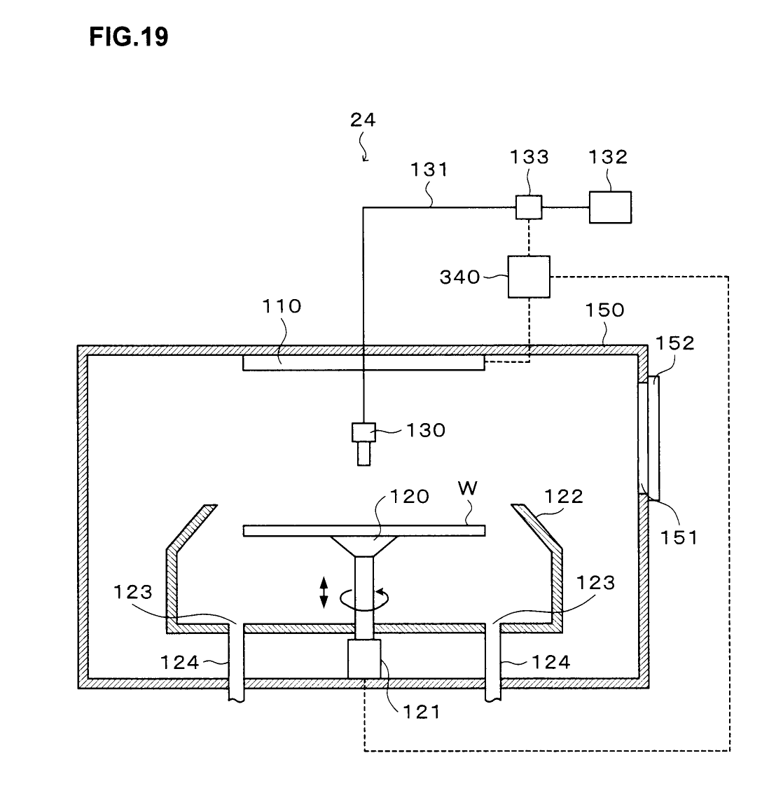

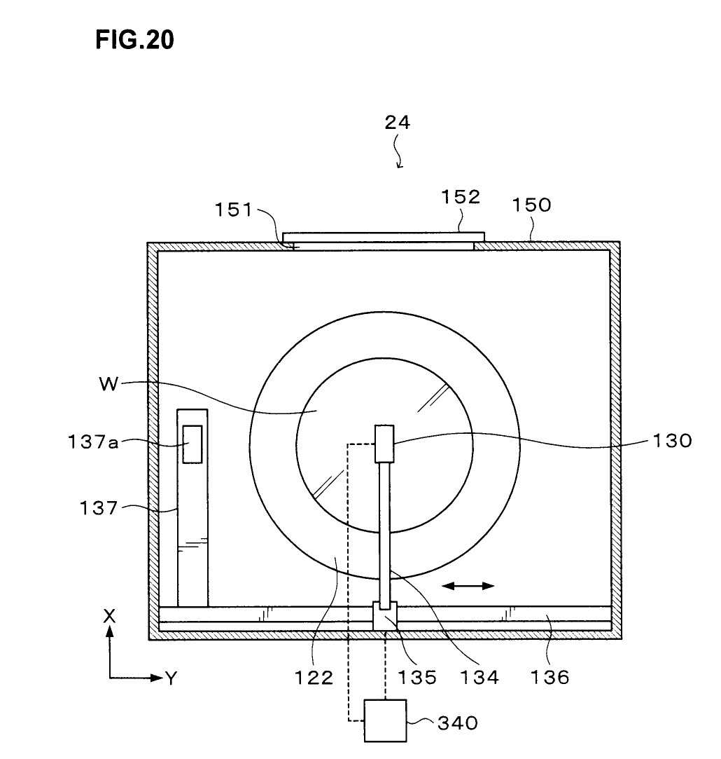

Next, another embodiment will be described. The coating treatment apparatus 24 in this embodiment includes a control unit 340 having a computer program for controlling a later-described series of operations as shown in FIG. 19 and FIG. 20. The control unit 340 is configured to control the irradiation unit 110, the rotary drive unit 121, the supply controller 133, the moving mechanism 135 and so on, and conducts control such that the time period from when the application of the coating solution by the coating nozzle 130 is completed to when the application of the ultraviolet rays by the irradiation unit 110 is started is within a predetermined time period. Note that the predetermined time period is set to a time period within which the sublimation amount of the applied coating solution falls within an allowable range when the wafer W above which the coating solution has been applied is left stand, for example, 20 seconds. The computer program is stored in a readable storage medium such as a hard disk (HD), a flexible disk (FD), a memory card, a compact disk (CD), a magneto-optical disk (MO), a hard disk, or the like, and installed to a computer being the control unit 340.

The coating and developing treatment system 1 incorporating the coating treatment apparatus 24 according to this embodiment is configured as described above, and wafer treatment performed in this coating and developing treatment system 1 will be described next.

As in the foregoing embodiment, first of all, one wafer W on which a predetermined pattern has been formed is taken out of the cassette C on the cassette mounting table 5 by the wafer transfer body 7 and transferred to the temperature regulating unit 60 in the third processing unit group G3. The wafer W transferred to the temperature regulating unit 60 is temperature-regulated to a predetermined temperature and then transferred to the coating treatment apparatus 24 according to the present invention. In the coating treatment apparatus 24, a later-described coating film is formed over the pattern on the wafer W.

After formation of the coating film over the pattern on the wafer W, the wafer W is transferred by the first transfer arm 10 into the bottom coating unit 23, where an anti-reflection film is formed. The wafer W above which the anti-reflection film has been formed is transferred by the first transfer arm 10 to the heating unit 92, the high-temperature thermal processing unit 65, and the high-precision temperature regulating unit 70 in sequence so that predetermined processing is performed in each of the units. Thereafter, the wafer W is transferred to the resist coating unit 20.

After a resist film has been formed above the wafer W in the resist coating unit 20, the wafer W is transferred by the first transfer arm 10 to the pre-baking unit 71 and subjected to heating processing and subsequently transferred by the second transfer arm 11 to the edge exposure unit 94 and the high-precision temperature regulating unit 83 in sequence so that the wafer W is subjected to predetermined processing in each of the units. Thereafter, the wafer W is transferred by the wafer transfer body 101 in the interface section 4 to the aligner (not shown) so that the resist film above the wafer W is exposed to light under a predetermined pattern. The wafer W for which exposure processing has been finished is transferred by the wafer transfer body 101, for example, to the post-exposure baking unit 84, where the wafer W is subjected to predetermined processing.

After completion of the thermal processing in the post-exposure baking unit 84, the wafer W is transferred by the second transfer arm 11 to the high-precision temperature regulating unit 81, where the wafer W is temperature-regulated, and then transferred to the developing treatment unit 30, where developing treatment is performed on the wafer W so that a pattern is formed in the resist film. The wafer W is then transferred by the second transfer arm 11 to the post-baking unit 75, where the wafer W is subjected to heating processing, and subsequently transferred to the high-precision temperature regulating unit 63, where the wafer W is temperature-regulated. The wafer W is then transferred by the first transfer arm 10 to the transition unit 61, and returned by the wafer transfer body 7 to the cassette C, with which a series of photolithography process ends.

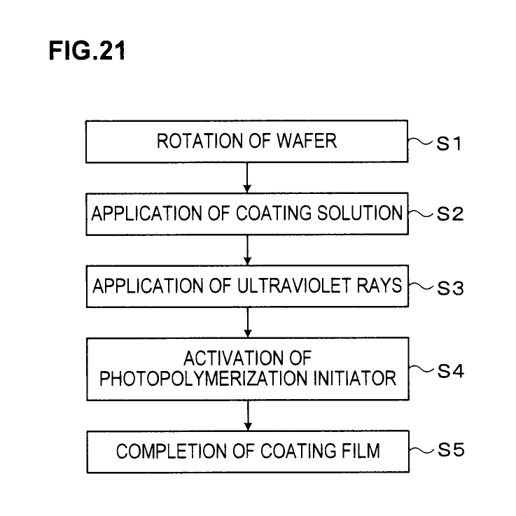

Next, a coating treatment method of forming a coating film having a film thickness of, for example, 100 nm to 300 nm over the pattern on the wafer W performed in the coating treatment apparatus 24 will be described. FIG. 21 shows a flow about the coating treatment method of forming the coating film.

The wafer W is transferred by the first transfer arm 10 into the treatment container 150 through the transfer-in/out port 151 and moved to above the spin chuck 120. The spin chuck 120 is then raised, and the wafer W is passed onto the spin chuck 120 from the first transfer arm 10. The wafer W is then sucked and horizontally held on the spin chuck 120 and then lowered to a predetermined position.

The wafer W is then rotated at, for example, a rotation speed of 500 rpm by the rotary drive unit 121, and the coating nozzle 130 is moved to above the central portion of the wafer W (Step S1). A coating solution Q is discharged, for example, for two seconds from the coating nozzle 130 onto the central portion of the wafer W, and the rotation is accelerated to, for example, about 1500 rpm and the wafer W is rotated for 15 seconds (Step S2). By the centrifugal force generated from the rotation of the wafer W, the coating solution Q is spread over the pattern P on the wafer W. The coating nozzle 130 is then moved from above the central portion of the wafer W to the waiting region 137.

After the coating solution Q is spread over the entire surface of the pattern P on the wafer W, the wafer W is raised to a predetermined position by the spin chuck 120. From the irradiation unit 110 onto the coating solution Q applied over the pattern P on the wafer W, ultraviolet rays having a wavelength of, for example, 222 nm and an energy of 7 mW/cm² is applied, for example, for 2 sec/cm² (Step S3). The applied ultraviolet rays activate the photopolymerization initiator contained in the coating solution Q and the activated photopolymerization initiator spreads to cure the coating solution Q (Step S4). Thus, a coating film R which is made by curing the coating solution Q is formed over the pattern P on the wafer W (Step S5).

According to the above embodiment, after the coating solution Q is applied onto the pattern P on the wafer W, the coating solution Q can smoothly spread over projections and depressions of the pattern P on the wafer W because the coating film forming component in the liquid state contained in the coating solution Q has good flowability. Accordingly, the surface of the coating film R to be formed over the pattern P on the wafer W can be planarized as shown at (b) in FIG. 6.

When the ultraviolet rays are applied to the photopolymerization initiator, the photopolymerization initiator is activated in a verv short time, for example, two seconds to cure the coating solution Q, thereby preventing sublimation of the coating solution Q.

Further, since the time period from when the application of the coating solution Q by the coating nozzle 130 is completed to when the application of the ultraviolet rays by the irradiation unit 110 is started is controlled by the control unit 340 to fall within a predetermined time period, for example, within 20 seconds, the amount of the coating solution Q which sublimates after the application of the coating solution Q is completed before the application of the ultraviolet rays is started can be suppressed to fall within the allowable range, thereby suppressing the reduction in film thickness of the coating film R to be formed into an allowable range.

In the case where, in order to form a thin film over a wafer of large diameter, the wafer is rotated at a high speed to spread the coating solution over the wafer, use of a conventional coating solution has created a region having an uneven film thickness at the end of the wafer that is a so-called “wind ripple.” The cause of creation of such a wind ripple is that the conventional coating solution has a coating film forming component in the solid state and a solvent and therefore a turbulent flow occurs to wave the coating film at the end of the wafer when the coating solution dries by evaporation of the solvent during the rotation of the wafer. In this respect, the coating solution Q of the present embodiment has a coating film forming component in the liquid state so that the coating solution Q is not likely to dry and cause such a wind ripple. Accordingly, even if the wafer W is rotated at a high speed to form a thin coating film R over the wafer W, the film thickness of the coating film R to be formed can be made constant.

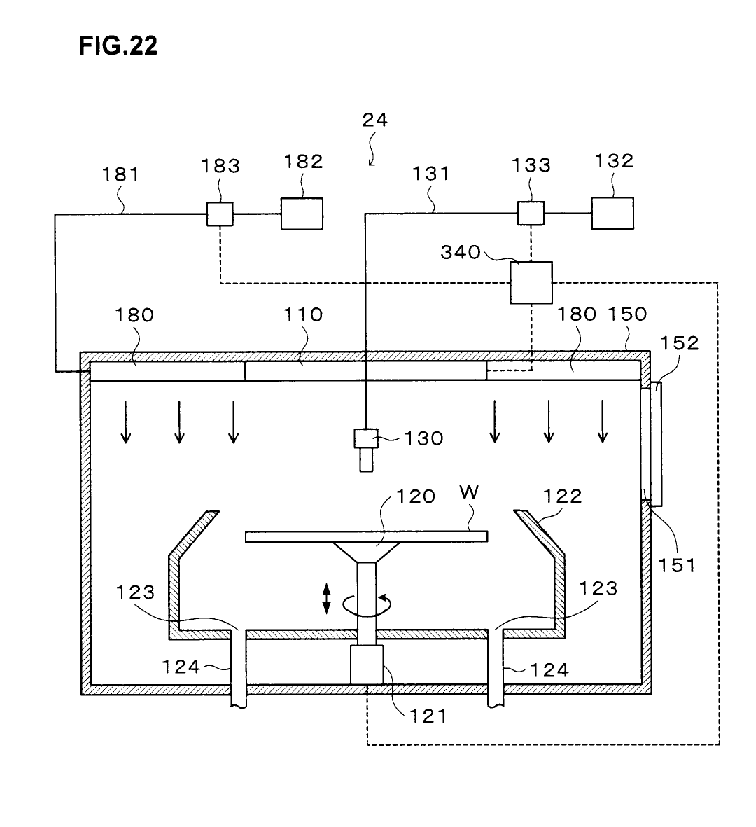

A gas supply unit 180 may be provided in the coating treatment apparatus 24 as shown in FIG. 22 to cool an atmosphere around the wafer W on the spin chuck 120. The gas supply unit 180 is provided in an upper portion in the treatment container 150. A lower surface of the gas supply unit 180 is formed with a plurality of holes (not shown), so that a gas is supplied downward from the plurality of holes. The gas supply unit 180 is connected to a gas supply source 182 that supplies a gas via a gas supply pipe 181. The supply pipe 181 is provided with a temperature and humidity regulator 183 that regulates the temperature and the humidity of the gas to be supplied.

In this case, at least the time when the coating solution Q is being applied onto the pattern P on the wafer W, or when the ultraviolet rays are being applied to the applied coating solution Q, the gas being supplied from the gas supply source 182 can be cooled by the temperature and humidity regulator 183 so that the cooled gas can be supplied from the gas supply unit 180 toward the inside of the treatment container 150 below it. As a result, the inside of the treatment container 150 can be cooled to a temperature lower than room temperature, for example, 15° C. This can cool the coating solution Q applied over the pattern P on the wafer W to further prevent the sublimation of the coating solution Q.

Further, the coating treatment apparatus 24 shown in FIG. 22 may be used to heat the atmosphere around the wafer W for a predetermined time after the coating solution Q is applied onto the pattern P on the wafer W and before the ultraviolet rays are applied to the applied coating solution Q.

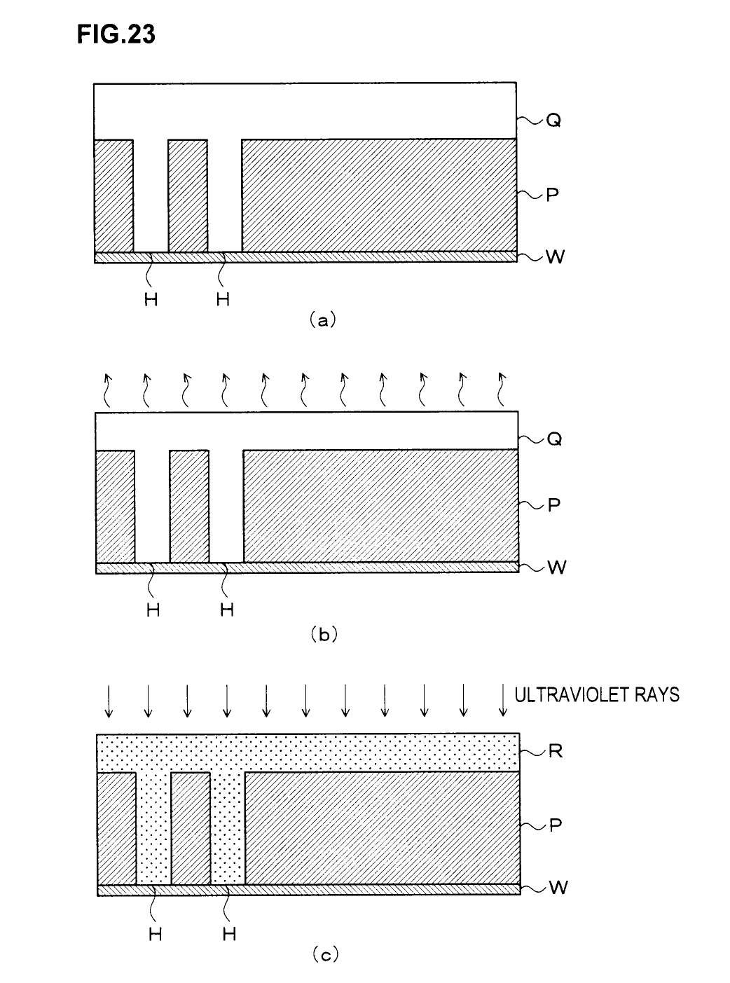

In this case, a coating solution Q is first applied over the pattern P on the wafer W by the coating nozzle 130 ((a) in FIG. 23). Thereafter, the thickness of the applied coating solution Q is measured by a film thickness detecting unit 95 shown in FIG. 3, and the measurement result is transmitted to the control unit 340. Based on the measurement result, if the thickness of the applied coating solution Q is larger than a predetermined thickness, the control unit 340 conducts control such that the atmosphere around the wafer W is heated for a predetermined time in order to sublimate a portion of the coating solution Q to make the coating solution Q into a predetermined thickness. More specifically, the heating temperature and time are calculated to control a large thickness variation by the heating temperature and control a small thickness variation by the heating time. The calculation results of the heating temperature and time are transmitted from the control unit 340 to the temperature and humidity regulator 183, and the gas supplied from the gas supply source 182 is heated in the temperature and humidity regulator 183. The heated gas is supplied from the gas supply unit 180 into the treatment container 150 to heat the atmosphere around the wafer W for a predetermined time. A portion of the coating solution Q over the pattern on the wafer W is then sublimated to make the thickness of the coating solution Q to a predetermined thickness ((b) in FIG. 23). Thereafter, when the coating solution Q remaining over the pattern P on the wafer W is made to have the predetermined thickness, the ultraviolet rays are applied from the irradiation unit 110 to the remaining coating solution Q to cure the coating solution Q ((c) in FIG. 23). This can form a coating film R having a predetermined film thickness over the pattern P on the wafer W.

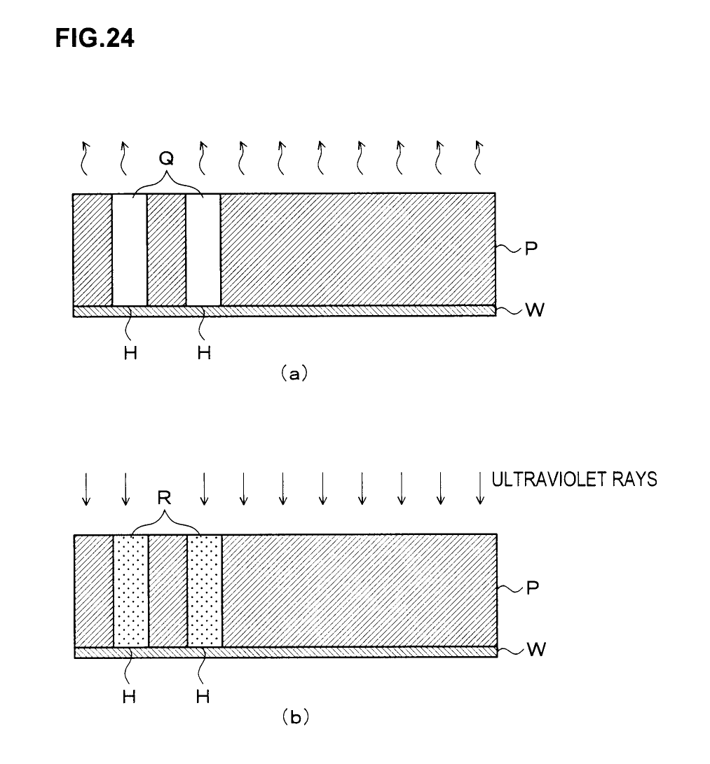

Further, heating the atmosphere around the wafer W for a predetermined time as described above can also sublimate all the coating solution Q applied over the surface of the pattern P except the recessed portions of the pattern P on the wafer W ((a) in FIG. 24). In other words, the film thickness of the coating film R formed over the pattern P is made zero so that the coating solution Q is filled and cured only in the recessed portions of the pattern P to thereby eliminate the projections and depressions of the pattern P, thereby planarizing the upper surface of the pattern P ((b) in FIG. 24). This can omit the etch-back process for removing the coating film R over the pattern P on the wafer W to improve the throughput of the treatment of the wafer W.

Besides, if the pattern of the resist film to be formed on the coating film R in the above embodiment is not a desired one, rework processing is performed on the wafer W. At the time of stripping the coating film R by the rework processing, the coating film R may be stripped by heating the atmosphere around the wafer W.

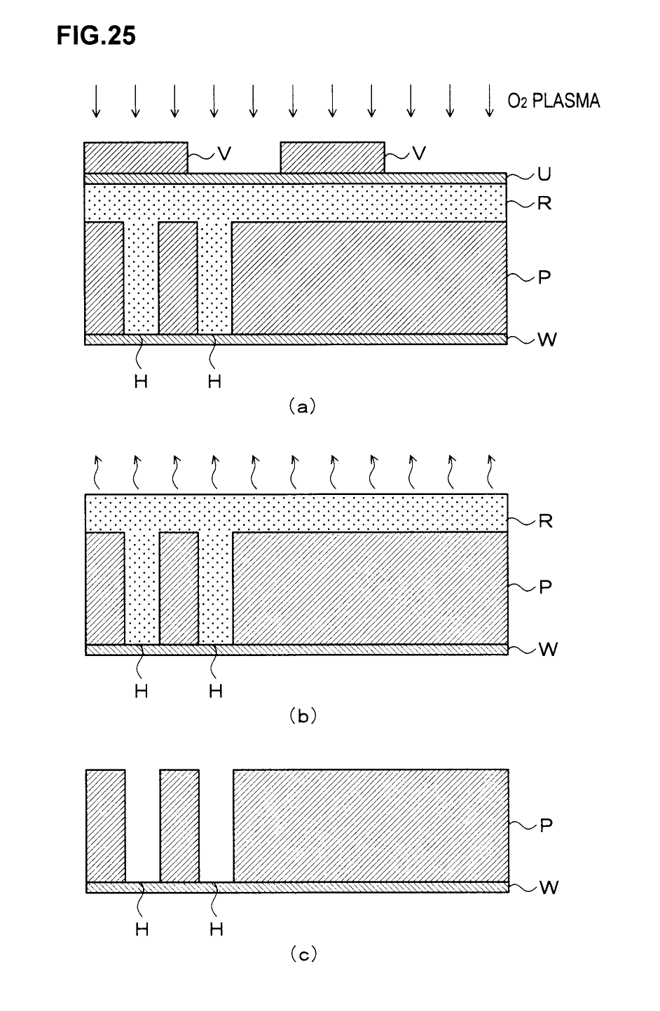

In this case, for example, O₂ plasma is applied first onto a pattern V of the resist film formed above and an anti-reflection film U formed on the coating film R to strip the pattern V of the resist film and the anti-reflection film U ((a) in FIG. 25). The atmosphere around the wafer W is heated to 250° C. to 350° C. ((b) in FIG. 25) to sublimate and strip the coating film R ((c) in FIG. 25).

By study of the sublimation of the coating film R, the inventors found that the coating film R in the present invention has a low-molecular coating film forming component and therefore decomposes and sublimates at a temperature of 250° C. or higher. Additionally, in consideration of the allowable temperature for the subsequent step (backend process) of the treatment of the wafer W, it is preferable to heat the coating film R at a temperature of 350° C. or lower. Accordingly, the heating temperature when sublimating the coating film R is preferably at 250° C. to 350° C.

The coating film R is stripped by heating it in the above embodiment, thereby eliminating the use of O₂ plasma or the like as in the prior art to make it possible to reduce or avoid the damage to the pattern P on the wafer W. Further, this can improve the decrease in yield in the rework processing of the wafer W.

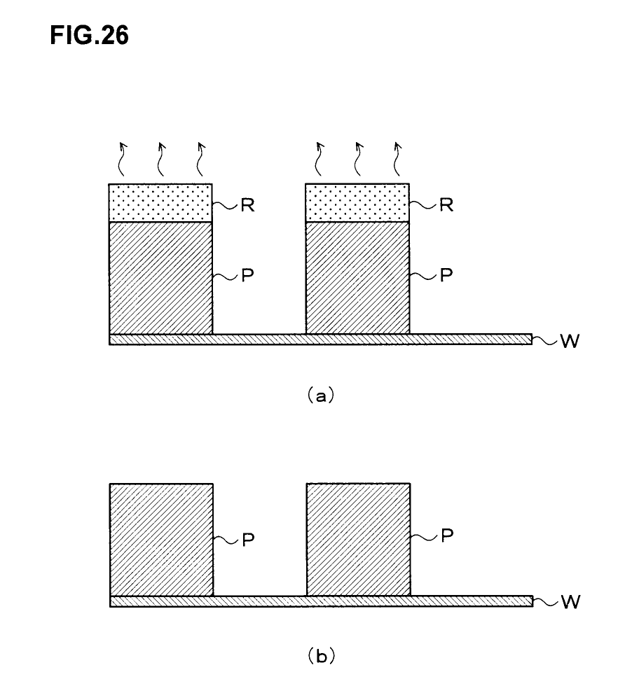

In addition, the method of stripping the coating film R by heating in the above embodiment is also useful in ashing the coating film R remaining on the pattern P after etching the wafer W using the pattern V of the resist film as a mask. In this case, the atmosphere around the wafer W is heated to 250° C. to 350° C. ((a) in FIG. 26) to sublimate and strip the coating film R ((b) in FIG. 26). This ensures that ashing of the coating film R remaining on the pattern P can be performed without damaging the pattern P on the wafer W.

Note that in the above embodiment, the process of curing the coating solution Q applied above the wafer W shown in Steps S3 to S5 in FIG. 21, the photopolymerization initiator of causing the coating solution Q to crosslink is activated by applying the ultraviolet rays to the coating solution Q, and the activated photopolymerization initiator is spread to cure the coating solution Q.

In the process of spreading the photopolymerization initiator, the spread of the photopolymerization initiator can be accelerated by heating the coating solution Q at a temperature of 100° C. to 130° C. In the curing process of the coating solution Q in this embodiment, the coating solution Q is cured not by the heating energy itself as in the prior art but by heating it at a temperature of 100° C. to 130° C. lower than the heating temperature in the prior art to spread the photopolymerization initiator in a short time, whereby the sublimation of the coating solution Q can be suppressed as compared in the prior art. Accordingly, the coating solution Q can be efficiently cured.

The coating film sublimates by heating the coating film of the present invention will be described hereinafter. In this embodiment, a coating film having a film thickness of about 140 nm was formed over a pattern on the wafer by the method described in FIG. 21, and the atmosphere around the wafer was heated at a temperature of 350° C.

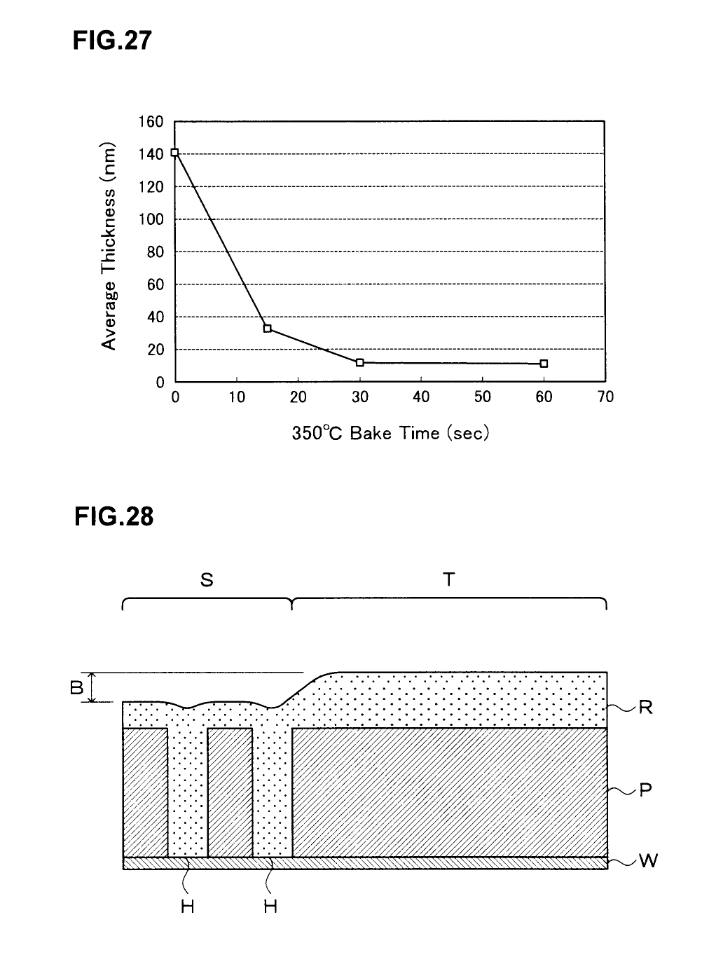

The result of measuring the variation with time in film thickness of the coating film after heating in the present embodiment is shown in FIG. 27. The vertical axis in FIG. 27 shows the average film thickness of the coating film and the horizontal axis shows the heating time. Referring to FIG. 27, the film thickness of the coating film is about 140 nm at the start of heating but reduces to about 10 nm after a lapse of about 60 seconds. Accordingly, it was found that the coating film of the present invention sublimates by heating the coating film at a predetermined temperature, for example, at 350° C.

Note that the coating film R formed in the above embodiment may be a resist film for forming the pattern P on the wafer W. The coating film R formed as described above can be used as the resist film to omit the process of forming the conventional resist film.

Preferred embodiments of the present invention have been described above with reference to the accompanying drawings, but the present invention is not limited to the embodiments. It should be understood that various changes and modifications within the scope of the spirit as set forth in claims are readily apparent to those skilled in the art, and those should also be covered by the technical scope of the present invention. The present invention is not limited to the embodiments but may take various forms. The present invention is also applicable to the case where the substrate is a substrate other than the wafer, such as an FPD (Flat Panel Display), a mask reticle for a photomask, or the like.

The present invention is useful in forming a coating film over a pattern formed on a substrate.

What is claimed is:

1. A coating treatment apparatus for forming a coating film over a pattern formed on a substrate, comprising:
a treatment container for housing the substrate, including a transfer-in/out port for transferring-in/out the substrate;
a coating nozzle for applying a coating solution containing a coating film forming component in a liquid state onto the pattern on the substrate housed in said treatment container; and
an irradiation unit for applying ultraviolet rays to the coating solution applied over the pattern on the substrate.

2. The coating treatment apparatus as set forth in claim 1,
wherein said irradiation unit is provided in an upper portion of said treatment container.

3. The coating treatment apparatus as set forth in claim 1,
wherein said irradiation unit is provided at an upper portion of the transfer-in/out port.

4. The coating treatment apparatus as set forth in claim 1, further comprising:
a rotatable spin chuck for holding the substrate, in said treatment container,
wherein a range where the ultraviolet rays are applied to the coating solution over the pattern on the substrate by said irradiation unit is a region from a center of the substrate to an end portion of the substrate and greater.

5. The coating treatment apparatus as set forth in claim 4,
wherein said irradiation unit is provided beside said coating nozzle.

6. The coating treatment apparatus as set forth in claim 1,
wherein said coating nozzle is a nozzle having a discharge port in a slit form extending in a direction of a width of the substrate, and
wherein said irradiation unit has a form extending in the direction of the width of the substrate parallel to said coating nozzle and moves in synchronization with said coating nozzle.

7. The coating treatment apparatus as set forth in claim 6,
wherein said irradiation unit is provided beside said coating nozzle.

8. The coating treatment apparatus as set forth in claim 6,
wherein said coating nozzle and said irradiation unit have independent moving mechanisms.

9. The coating treatment apparatus as set forth in claim 6,
wherein a plurality of said irradiation units are provided.

10. The coating treatment apparatus as set forth in claim 4, further comprising:
a control unit for conducting control such that the ultraviolet rays are applied from said irradiation unit to the coating solution on the region of the substrate immediately after the coating solution is applied onto the region from said coating nozzle.

11. A substrate treatment system comprising a coating treatment apparatus for applying a coating solution onto a pattern formed on a substrate, and a transfer unit for transferring the substrate into/from the coating treatment apparatus,
wherein said transfer unit comprises a transfer arm for supporting and transferring the substrate, and an irradiation unit for applying ultraviolet rays to the coating solution over the pattern on the substrate, the substrate being supported by said transfer arm.

12. A coating treatment method of forming a coating film over a pattern formed on a substrate,
a coating solution for forming the coating film containing a coating film forming component in a liquid state and a solvent, the coating film forming component containing a photopolymerization initiator,
said method comprising:
a coating step of applying the coating solution onto the pattern on the substrate; and
an irradiation step of applying ultraviolet rays to the coating solution applied over the pattern on the substrate to activate the photopolymerization initiator to form a coating film.

13. The coating treatment method as set forth in claim 12,
wherein a time period from when said coating step is completed to when said irradiation step is started is controlled to be within a predetermined time period.

14. The coating treatment method as set forth in claim 12,
wherein a time period from when the coating solution is applied in said coating step to when the ultraviolet rays are applied in said irradiation step is controlled to be constant in an entire region within the plane of the substrate.

15. The coating treatment method as set forth in claim 12,
wherein the application of the ultraviolet rays in said irradiation step is performed for the coating solution on a region of the substrate immediately after the coating solution is applied onto the region.

16. The coating treatment method as set forth in claim 12,
wherein said coating step and/or said irradiation step are/is performed with an atmosphere around the substrate being cooled.

17. The coating treatment method as set forth in claim 12, further comprising:
after said coating step and before said irradiation step,
a heating step of heating an atmosphere around the substrate for a predetermined time to sublimate the coating solution applied over the pattern on the substrate until the coating solution has a predetermined thickness.

18. The coating treatment method as set forth in claim 12, further comprising:
after said irradiation step, a heating step of heating an atmosphere around the substrate for a predetermined time to sublimate the coating film formed over the pattern on the substrate.

19. The coating treatment method as set forth in claim 12,
wherein the coating film is a resist film for forming a pattern on the substrate.

20. A readable computer storage medium storing a program running on a computer of a control unit for controlling a coating treatment apparatus or a substrate treatment system to cause the coating treatment apparatus or the substrate treatment system to perform a coating treatment method of forming a coating film over a pattern formed on a substrate,
a coating solution for forming the coating film containing a coating film forming component in a liquid state and a solvent, the coating film forming component containing a photopolymerization initiator,
said coating treatment method comprising:
a coating step of applying the coating solution onto the pattern on the substrate; and an irradiation step of applying ultraviolet rays to the coating solution applied over the pattern on the substrate to activate the photopolymerization initiator to form a coating film.
